(19) United States
(12) Patent Application Publication
(10) Pub. No.: US 2016/0142226 A1
(43) Pub. Date: May 19, 2016

(54) METHOD FOR PACKET TUNNELING THROUGH SOFTWARE DEFINED NETWORK, METHOD OF INTELLIGENTLY CONTROLLING FLOW OF A PACKET THROUGH SOFTWARE DEFINED NETWORK AND SYSTEM

(71) Applicant: Huawei Technologies Co., Ltd., Shenzhen (CN)

(72) Inventors: Jing HUANG, Shenzhen (CN); Ting ZOU, Shenzhen (CN); Min ZHA, Shenzhen (CN); Xushan LU, Shenzhen (CN)

(21) Appl. No.: 15/006,829

(22) Filed: Jan. 26, 2016

Related U.S. Application Data
(63) Continuation of application No. PCT/CN2014/083720, filed on Aug. 5, 2014.
Application No. PCT/CN2014/083720 is a continuation of application No. 61/862,400, filed on Aug. 5, 2013.

(51) Int. Cl. H04L 12/46; H04L 12/931; H04L 12/741

(52) U.S. Cl. CPC H04L 12/4633; H04L 45/745; H04L 49/70; H04L 45/741

(57) ABSTRACT

Embodiments of the disclosure provide a method for packet tunneling through a software defined network (SDN), a method of intelligently controlling flow of a packet through an SDN network, and a system. The method for packet tunneling through an SDN includes: sending programmable instructions to an SDN controller from a processor executing an application program that includes the programmable instructions; wherein the programmable instruction comprises primitive operations regarding processing a packet for tunneling in accordance with a tunneling protocol; configuring a flow table by the first SDN controller in accordance with the programmable instructions; and processing and distributing the packet in accordance with the flow table by the SDN switch. The method may enable a system support multiple tunneling technologies without complicating the implementation of the SDN switch, and enable the system support new tunneling technologies without the need for updating the SDN switch, thereby reducing complexity of the SDN switch.

### CROSS-REFERENCE TO RELATED APPLICATIONS

This application is a continuation of International Patent Application No. PCT/CN2014/083720, filed on Aug. 5, 2014, which claims priority to U.S. Provisional Application No. 61/862,400, filed on Aug. 5, 2013, both of which are hereby incorporated by reference in their entireties.

### TECHNICAL FIELD

Embodiments of the disclosure relate to the communications field, and in particular, to a method for packet tunneling through a software defined network (SDN), a method of intelligently controlling flow of a packet through an SDN network, and a system for tunneling used in an SDN.

### BACKGROUND

The conventional Software defined network (SDN) technologies, e.g., the Openflow protocol used to interface an SDN controller and an SDN switch, can only provide limited support to selected tunneling technologies or protocols, such as GRE, MPLS, VLAN. Many commonly used tunneling protocols, such as IP-in-IP tunnel, VXLAN, NVGRE, and etc., are typically not supported by the conventional art. Moreover, based on the conventional technologies, an SDN system implementation typically is customized to support a specific tunneling technology, e.g., making decisions solely based on local logic depending on a packet. If an SDN system implementation is to be used to support more tunneling technologies, the forwarding plan tends to become undesirably complicated and usually involve update with each added tunneling technology.

### SUMMARY

An objective of embodiments of the disclosure is to provide a communication method for packet tunneling through an SDN, a computer implemented method of intelligently controlling flow of a packet through an SDN network, and a system for tunneling used in an SDN.

The technical solutions of the embodiments of the disclosure include the following content:

A communication method for packet tunneling through an SDN includes: sending programmable instructions to an SDN controller from a processor executing an application program that includes said programmable instructions; wherein said programmable instruction comprises primitive operations regarding processing a packet for tunneling in accordance with a tunneling protocol; configuring a flow table by said first SDN controller in accordance with said programmable instructions; and processing and distributing said packet in accordance with said flow table by said SDN switch.

Optionally, where said programmable instructions are transparent to said SDN switch.

A system for tunneling used in an SDN includes: an SDN controller, configured to receive instructions comprise operations of adding tunneling information to and removing tunneling information from a packet in accordance with a tunneling protocol, said instructions sent from a processor executing an application program; and configure a flow table associated with an SDN switch in accordance with said instructions; and an SDN switch, coupled to said SDN controller and configured to perform actions based on said flow table to distribute said packet in accordance with said tunneling protocol through said SDN network.

A computer implemented method of intelligently controlling flow of a packet through an SDN network, said method comprising configuring primitive operations regarding processing a packet for tunneling in accordance with a tunneling protocol, wherein said primitive operations comprise adding tunneling information to and/or removing tunneling information from a packet in accordance with said tunneling protocol, wherein said primitive operations are used by an SDN controller to configure a flow table, and wherein said flow table is used by an SDN switch to perform said primitive operations to distribute and/or receive a packet in accordance with said tunneling protocol.

Optionally, where said primitive operations are configured as respective data structures.

Optionally, where said SDN switch generic with respect to tunneling protocols.

An advantage of the embodiments of the disclosure is that the method may enable an SDN system to support multiple tunneling technologies without complicating the implementation of an SDN switch, and may enable the SDN system to support new tunneling technologies that have not been supported by the conventional art without the need for updating the SDN switch, which implementing packet tunneling through an SDN and reducing complexity of the SDN switch.

### BRIEF DESCRIPTION OF DRAWINGS

To illustrate the technical solutions in the embodiments of the disclosure more clearly, the accompanying drawings required for describing the embodiments are briefly described in the following. Apparently, the accompanying drawings in the following description merely show some embodiments of the disclosure, and persons of ordinary skill in the art may still derive other drawings from the accompanying drawings without creative efforts.

FIG. 1 is a schematic structural diagram of an SDN network according to an embodiment of the disclosure;

FIG. 2 is a flowchart of implementing a method according to an embodiment of the disclosure;

FIG. 3 is a schematic diagram of a packet format that can be used for PBB tunneling protocol according to an embodiment of the disclosure;

FIG. 4A is a schematic diagram of a packet format that can be used for DS-Lite tunneling protocol according to an embodiment of the disclosure;

FIG. 4B is a schematic structural diagram of an SDN network that employs a DS-Lite tunneling method according to an embodiment of the disclosure;

FIG. 5 is a schematic diagram of a VxLAN header format according to an embodiment of the disclosure;

FIG. 6 is a schematic diagram of an NVGRE header format according to an embodiment of the disclosure;

FIG. 7 is a schematic diagram of an MPLS header format according to an embodiment of the disclosure.

### DESCRIPTION OF EMBODIMENTS

To make the objectives, technical solutions, and advantages of the embodiments of the disclosure clearer, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

Therefore, it would be advantageous to provide a method to enable an SDN system to support multiple tunneling technologies without complicating the implementation of an SDN switch. It would also be advantageous to enable an SDN system to support new tunneling technologies that have not been supported by the conventional art without the need for updating the SDN switch.

Accordingly, the embodiments of the present disclosure employ an application program comprising instructions to configure an SDN switch flow table with primitive operations to implement tunneling. The primitive operations comprise adding tunneling information to, or encapsulating, a packet at an entry-point of a tunnel, and removing the tunneling information from, or decapsulating, a packet at an exit-point of a tunnel. The tunneling information may comprise header information as dictated by specifications of respective well known packet formats. The primitive operations may comprise pushing and popping the header information to configure a tunneling packet. Embodiments of the present disclosure may also push the tunneling information to metadata. The primitive operations may be implemented as data structures in an application program. An SDN controller, e.g., a centralized controller, can configure a flow table within an individual SDN switch based on the primitive operations as well as other instructions provided by the application program. The individual SDN switch can then take actions with respect to the packet based on the flow table. Therefore, the details of tunneling technology are placed in the application programs, while SDN switches are used to implement a set of primitive operations. This mechanism advantageously offers a generalized and extendable approach to support a wide variety of tunneling technologies, including non-standard tunneling technologies

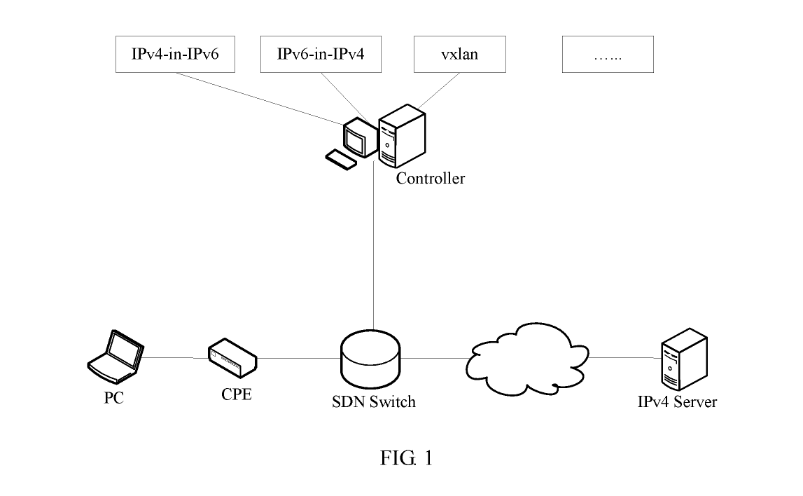

FIG. 1 is a block diagram illustrating an exemplary SDN network of a data transmission network capable of supporting a diversity of tunneling technologies in accordance with an embodiment of the present disclosure. A variety of application programs, e.g., including instructions for tunneling packets, can configure SDN switches on the network to adapt the data packets from one protocol to another. A tunneling application program is specific to the respective tunneling technology, e.g., IPv4-in-IPv6, IPv6-in-IPv4, Vxland, etc. Such a program may contain details of a tunneling technology for processing data packets, such as pushing and popping a corresponding header. However, the tunneling technologies can be transparent to the SDN switches that execute instructions defined by the tunneling application program. Therefore, a generic SDN switch may be advantageously capable of supporting a variety of tunneling technologies.

As will be appreciate by those skilled in the art, the present disclosure is not limited to any specific type of tunneling technology. To name a few, the present disclosure can support MPLS, PBB, IP-in-IP (IPv4-in-IPv6, IPv6-in-IPv4), GRE, VXLAN, NVGRE, GPRS, PPPoE, CAPWAP, and so on.

```
TABLE 1
Struct push_mac {
  src_mac;
  dst_mac;
  ethertype;
    }
struct pop_mac {
  // no parameter
}
```

Table 1 provides exemplary data structures defining actions for pushing and popping a MAC header on a packet in accordance with an embodiment of the present disclosure. The push_mac operation can be performed at a tunnel entry point to add the header to a packet, and the pop_mac operation can be performed at a tunnel node exit-point to remove the header from the packet. The parameters, e.g., src_mac, dst_mac, ethertype, are defined as dictated by the MAC protocol. In some embodiment, the MAC header is pushed/popped as the outmost header of a packet, e.g., as a default.

TABLE 2

| Struct push_vlan { | |
|---|---|
| position; | // where to push |
| ethertype; | |
| vlanid; | |
| priority; | |
| } | |
| struct pop_vlan { | |
| position; | // where to pop |
| } | |

Table 2 provides exemplary data structures defining operations pushing and popping a VLAN header on a packet in accordance with an embodiment of the present disclosure. The pushing data structure comprises the position of the packet to push the header, the Ethernet type, the VLAN ID, and the priority. The popping data structure comprises a position to pop the header, such as the outmost header or the header following the MAC header.

TABLE 3

| Struct push_ip { | |
|---|---|
| position; | // where to push |
| af; | // ipv4, ipv6 address family |
| src_addr; | //source IP address |
| dst_addr; | //destination IP address |
| protocol; | //IP header protocol type |
| } | |
| struct pop_ip { | |
| position; | // where to pop |
| af; | // ipv4, ipv6 address family |
| } | |

Table 3 provides exemplary data structures defining operations for pushing and popping an IP header on a packet in accordance with an embodiment of the present disclosure. In this example, the data structures do not include all the header fields dictated by a IP packet format. As will be appreciated by those skilled in the art, other parameters for additional header fields can be added to the data structure in some embodiments. In some embodiments, an SDN switch may be capable of filling in the default values for header fields unspecified in the data structures while performing the action. Alternatively, the values of those unspecified header fields can be derived from information included an inner layer header. For example, if the application program is configured for a IPv4-in-IPv6 tunnel, some header fields of the outer IPv6 packet header can be derived from the inner IPv4 packet header, such as TTL.

TABLE 4

| Struct push_tp { | |
|---|---|
| position; | // where to push |
| protocol; | // TCP/UDP |
| src_port; | //source port |
| dst_port; | //destination port |
| } | |
| struct pop_tp { | |
| position; | // where to pop |
| protocol; | // TCP/UDP |
| } | |

Table 4 provides exemplary data structures defining operations for pushing and popping a transportation layer (TCP/UDP) header on a packet in accordance with an embodiment of the present disclosure. For example, the position specifies where to push/pop the TCP/UDP header to a packet. For example, position=1 means pushing/popping a TCP/UDP header at the beginning of a packet, or position=0 means pushing/popping a TCP/UDP header following a MAC header or the VLAN header if present. In this example, the data structures do not include all the header fields dictated by a TCP/UDP packet format. As will be appreciated by those skilled in the art, other parameters for additional header fields can be added to the data structure in some embodiments.

Requisite tunneling information to be added to a packet can also be added to a packet as metadata in accordance with embodiments of the present disclosure. This approach is particularly useful to support experimental, non-standard, or future new tunneling technologies. In some embodiments, the content of the metadata can be transparent to an SDN Switch. Thus a generic SDN switch can be used to support multiple tunneling protocols and new tunneling protocols, which may significantly simplify the implementation of the SDN switch, and circumvent the need for SDN switch update or upgrade in order to support new tunneling technologies. However, as will be appreciated by those skilled in the art, the present disclosure is not limited to any specific type of SDN switch. The SDN switch may only be generic with respect to selected tunneling protocols. It may include local logic customized for selected tunneling technologies but still capable of support other tunneling technologies in accordance with the primitive operations included in the API.

TABLE 5

| Struct push_metadata { | |
|---|---|
| position; | // where to push |
| length; | //metadata length |
| metadata; | //content of metadata |
| } | |
| struct pop_metadata { | |
| position; | //where to pop |
| len; | // length to be popped |
| } | |
| Struct metadata_to_flow { | |
| position; | |
| offset; | //relative to the position |
| length; | //less than or equal to the mask length |
| mask ; | |
| } | |
| Struct metadata_to_packet { | |
| position; | |
| offset; | |
| length; | // length |
| value; | |
| } | |

Table 5 provides exemplary data structures defining operations for pushing, popping and modifying metadata on a packet in accordance with an embodiment of the present disclosure. The parameter “mask” can be used to specify which bits to write/read. For example, if the total length is 64 bits and lower 16 bits are to be written, then the mask value can be 0x00 00 00 00 00 00 FF. The structure push_metadata comprises the position, length, and metadata content. In some embodiments, the position parameter can be selected from

### DEFINITION OF POSITION

0 default (behind mac, vlan, ip, tcp/udp)

1 Starting point of a packet

2 Behind MAC

3 Behind VLAN

4 Behind IP

5 Behind TCP/UDP

The structure metadata_to_flow comprises parameters for extracting values from metadata and use them for flow table match. The structure metadata_to_packet defines parameters for modifying metadata section in a packet, for example change the a GRE packet.

TABLE 6

| Struct flow { | |
|---|---|
| src_mac; | |
| dst_mac; | |
| . . . . . . | |
| metadata; | // e.g. 64bit |
| . . . . . . | |
| other fields | |
| } | |

When handling a packet encapsulated inside a tunneling header with metadata in it, part or all of the metadata in the header can be put into metadata field in a flow structure for flow table lookup. Table 6 is an exemplary flow structure that includes metadata field in accordance with an embodiment of the present disclosure. Such a data structure, or part of it, can be used as a key for flow table lookup. The metadata field in the structure can have fixed or variable length.

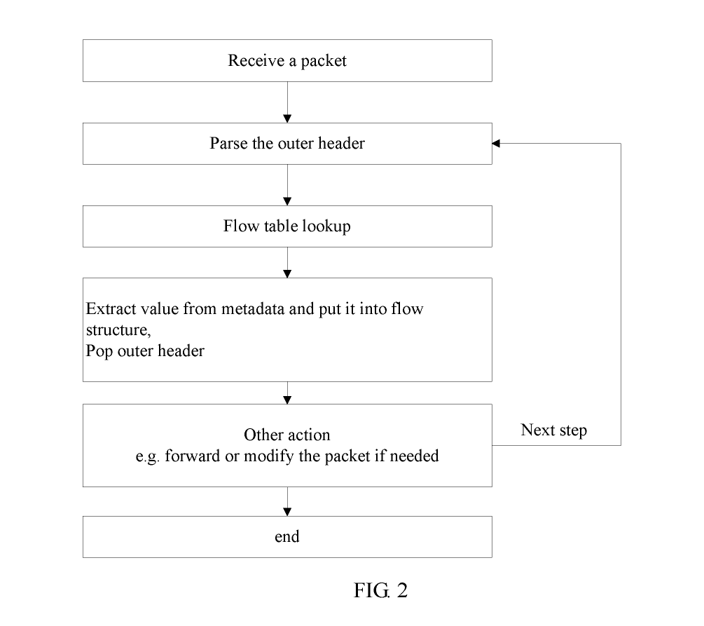

When an SDN switch receives a packet, it extracts relevant information from the packet for flow table look up, for example the information in the MAC header or IP header. For a field that can not be recognized by the SDN switch, e.g., the metadata field, the SDN switch may not be able to process the field and the corresponding tunneling protocols. Thus, the tunneling information as part of the metadata can be added to the flow table lookup to process, for example based on the TNI in the NVGRE or the VNI in VxLAN, without adding all the metadata to the lookup table. FIG. 2 is a flow chart illustrating an exemplary method of extracting a specified length of data from the metadata for flow table lookup. The flow lookup table can be provided by a corresponding application program including tunneling primitive operations. The lookup table comprises a metadata field storing information extracted from the packet metadata.

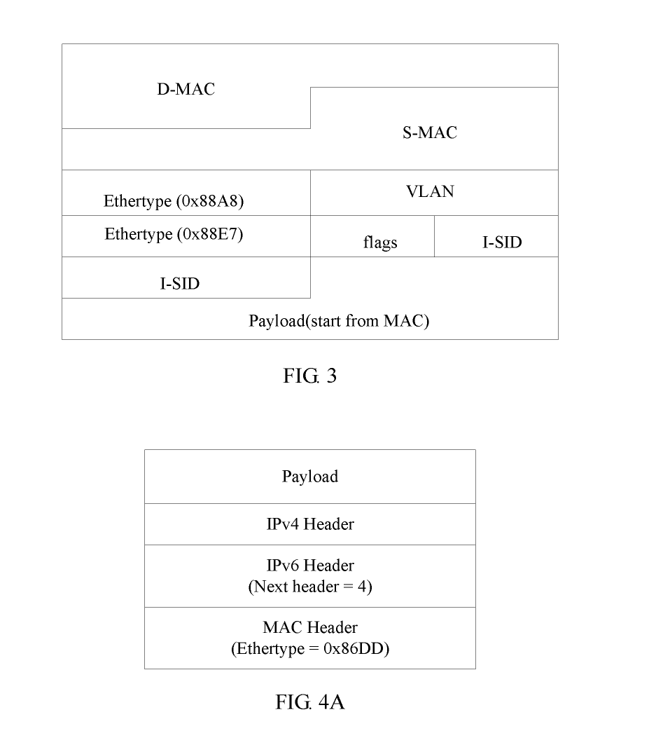

FIG. 3 illustrates an exemplary packet format that can be used for PBB tunneling protocol in accordance with an embodiment of the present disclosure. The PBB tunneling packet comprises a MAC header, a VLAN header, PBB fields including flags, 24 bits I-SID, and payloads. For instance, if a MAC packet with destination address of AA:BB:CC:DD:EE:FF is to be encapsulated in the tunnel, a PBB tunneling application program can distribute a flow table to the SDN switch, as show in Table 7.

```
TABLE 7
Match:
  s-mac=AA:BB:CC:DD:EE:FF
Actions:
  push_metadata(position=1, len=4bytes, medatada),
  push_vlan(position=1,ethertype=0x88E7,vlanid,priotiry),
  push_mac(position=1, s-mac,d-mac,ethertype=0x88A8)
```

If an SDN switch receives a packet comprising a PBB encapsulation, it can perform a decapsulation process as shown in Table 8. As will be appreciated by those skilled in the art, any other suitable flow structure can be used to implement the similar method in accordance with the present disclosure.

```
TABLE 8
  Table 0:
  Match:
    s-mac=AA:AA:AA:AA:AA:AA,
    d-mac=BB:BB:BB:BB:BB:BB,
    ethertype=0x88A8
    actions: pop_mac, goto_next_table(1)
table 1:
Match: VLANID=xx,ethertype=0x88E7
Actions: pop_vlan:position=1
      Metadata_to_flow: position=1, offset=1, len=3, mask=0xfff
      Pop_metadata: position=1,len=4
      Goto_next_table(2)
Table 2:
Match: others
Actions: others
```

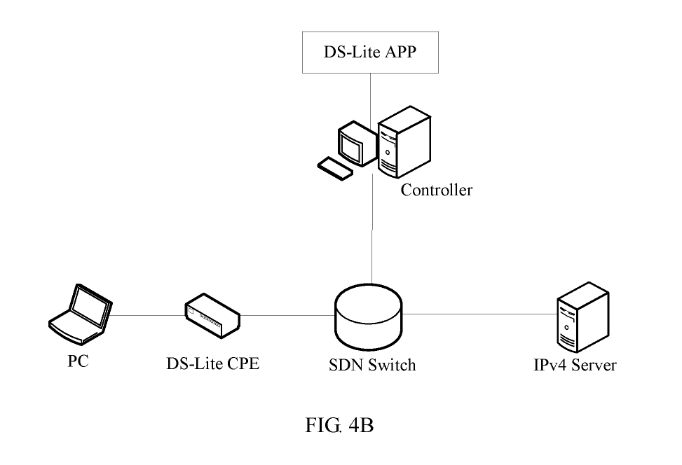

IP-in-IP tunnels, including IPv4-in-IPv6, IPv6-in-IPv4 are widely used in IPv6 transition technologies. For example, DS-Lite, MAP-E, LW4over6, 4RD, etc, make use of IPv4-in-IPv6 tunnel; and 6RD makes use of IPv6-in-IPv4 tunnel. FIG. 4A illustrates an exemplary packet format that can be used for DS-Lite (IPv4-in-IPv6) tunneling protocol in accordance with an embodiment of the present disclosure. FIG. 4B illustrates an exemplary SDN network that employs the DS-Lite tunneling method in accordance with an embodiment of the present disclosure.

TABLE 9

| Actions in up stream direction: | |
|---|---|
| Pop_mac: | |
| Pop_ip: pos=1, af=ipv6 | |
| modify-ip-src(A.B.C.D) | |
| modify-src-port(EEFF) | |
| Actions in down stream direction: | |
| modify-ip-dst(a.b.c.d), | |
| modify-src-port(eeff), | |
| Pop-mac | // pop old ethernet header |

```
  push-ip (pos=1, af=ipv6, src=hh:kk,dst=xx::yy, protocol=4)
  Push-mac: s-mac, d-mac, ethertype=0x86DD
```

Table 9 provides exemplary actions in an upstream direction and a downstream direction of a DS-Lite tunnel, respectively, in accordance with an embodiment of the present disclosure.

Table 10 provides exemplary instructions for push actions used in a IP-in-IP tunnel in accordance with an embodiment of the present disclosure. In this embodiment, when pushing an IP header, by default it is inserted behind MAC header; if VLAN header presents, it is inserted behind VLAN header. The Ethertype field in MAC header or VLAN header can be set to 0x800 if IPv4 header is inserted, and 0x86DD if IPv6 header is inserted.

If the payload above the inserted IP header is IPv4, then the protocol field of inserted IPv4 header or next-header field of IPv6 is set to 4. If the payload above the inserted IP header is IPv6, then the protocol field of inserted IPv4 header or next-header field of IPv6 can be set to 41. Other fields of inserted IP header can be derived from the IP header in payload, or take a default value. If the inserted IP header and the original IP header belong to different address families, e.g. IPv4 and IPv6, a mapping process can be used, which may result in loss of some field. The flow-label in IPv6 may not be mapped to IPv4 header.

```
TABLE 10
enum ofp_action_type {
  OFPAT_PUSH_IPV4 = xxxx (TBD),
  OFPAT_PUSH_IPV6 = xxxx (TBD)
};
struct ofp_action_push_ipv4 {
```

| | |
|---|---|
| uint16_t type; | /* OFPAT_PUSH_IPV4 */ |
| uint16_t len; | /* Length is 16 */ |
| uint32_t src_addr; | /* source ip address */ |
| uint32_t dst_addr; | /* dest ip address */ |

uint8_t pad[4];
};
OFP_ASSERT(sizeof(struct ofp_action_push_ipv4) == 16);
struct ofp_action_push_ipv6 {

| | |
|---|---|
| uint16_t type; | /* OFPAT_PUSH_IPV6 */ |
| uint16_t len; | /* Length is 40 */ |
| uint32_t src_addr[4]; | /* source ip address */ |
| uint32_t dst_addr[4]; | /* dest ip address */ |
| uint8_t pad[4]; | |

Table 11 provides exemplary instructions for pop actions used in an IP-in-IP tunnel in accordance with an embodiment of the present disclosure. When an IP header is removed, the Ethertype field in the underlying MAC or VLAN header should be updated accordingly.

TABLE 11

| enum ofp_action type { | |
|---|---|
| OFPAT_POP_IPV4 == xxxx (TBD), | |
| OFPAT_POP_IPV6 == xxxx (TBD) | |
| }; | |
| struct ofp_action_pop_ipv4 { | |
| uint16_t type; | /* OFPAT_POP_IPV4. */ |
| uint16_t len; | /* Length is 8. */ |
| uint8_t pad[4]; | |
| }; | |
| OFP_ASSERT(sizeof(struct ofp_action_pop_ipv4) == 8); | |
| struct ofp_action_pop_ipv4 { | |
| uint16_t type; | /* OFPAT_POP_IPV6. */ |
| uint16_t len; | /* Length is 8. */ |
| uint8_t pad[4]; | |

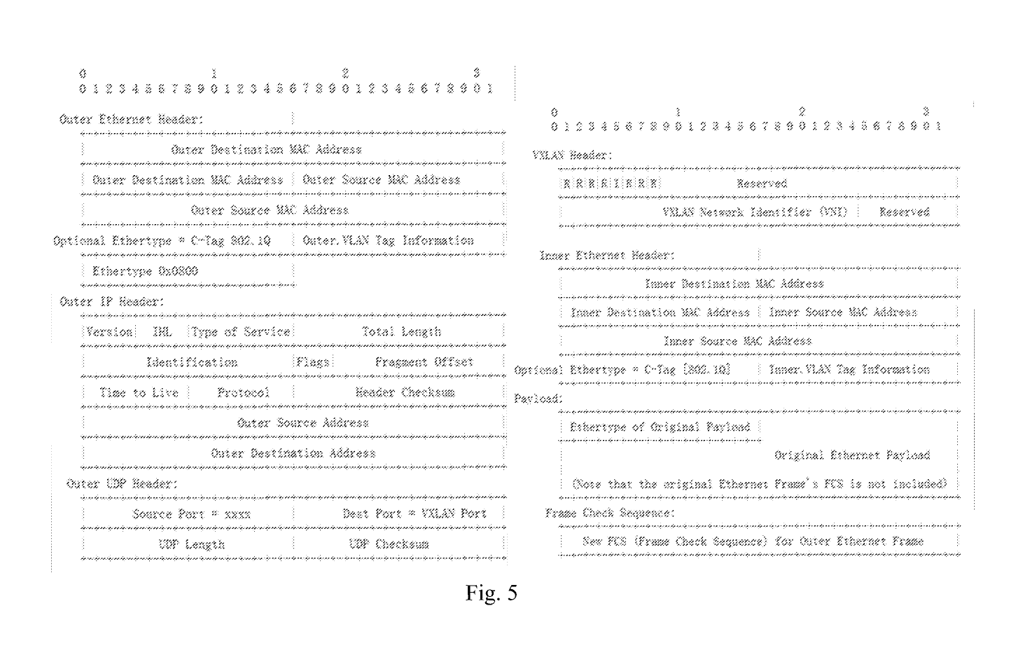

FIG. 5 illustrates VxLAN header format that can be processed in accordance with embodiment of the present disclosure. Table 12 provides exemplary tunnel encapsulation and decapsulation processes for a VXLAN tunnel packet by use of metadata.

```
TABLE 12
Tunnel encapsulation:
  1. Push_metadata: pos=1, len=8, metadata
  2. Push_tp: pos=1, proto=udp, src_port, dst_port
  3. Push_ip: pos=1, proto=udp, src_ip, dst_ip
  4. Push_vlan: pos=1, vlanid, priority, ethertype=0x800
  5. Push_mac: src_mac, dst_mac, ethertype=0x8100
Tunnel decapsulation:
  1. Pop_mac
  2. Pop_vlan: pos=1
  3. Pop_ip: pos=1, af=ipv4
  4. Pop_tp: pos=1, proto=udp
  5. Metadata to flow pos=1 offset=4 len=2 mask=0xFFFFFF
```

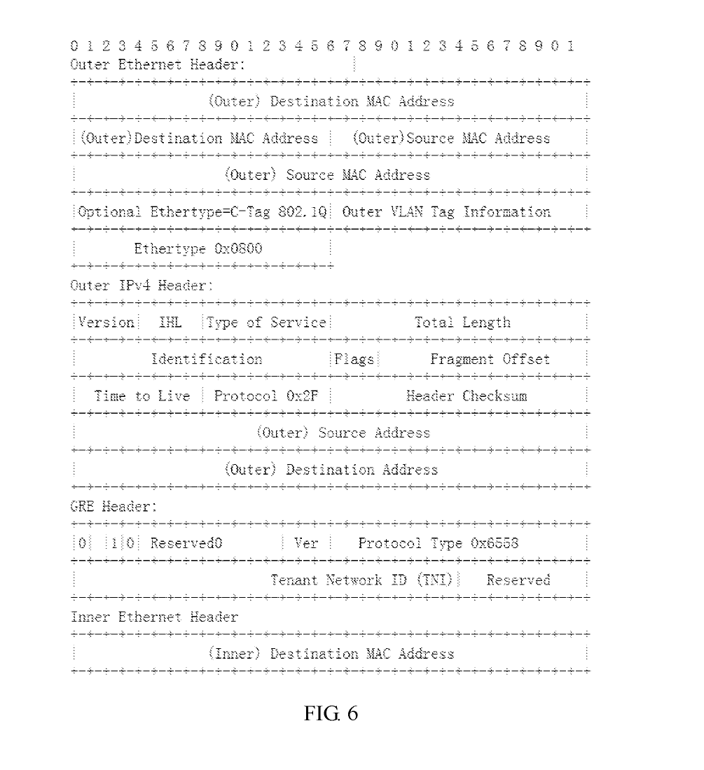

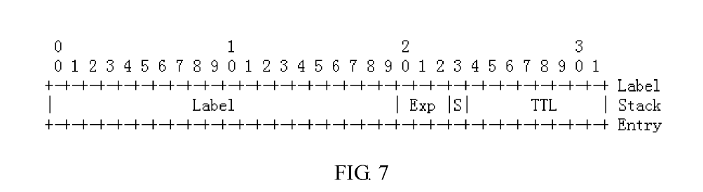

FIG. 6 illustrates NVGRE header format that can be processed in accordance with embodiment of the present disclosure. FIG. 7 illustrates MPLS header format that can be processed in accordance with embodiment of the present disclosure.

In the embodiments of the disclosure, GRE may be fully spelled as Generic Routing Encapsulation in English, and GRE may be the abbreviation of generic routing encapsulation in English. MPLS may be fully spelled as Multiprotocol Label Switching in English, and MPLS may be the abbreviation of Multiprotocol Label Switching in English. IP may be fully spelled as Internet Protocol in English, and IP may be the abbreviation of Internet Protocol in English. VXLAN may be fully spelled as Virtual Extensible Local Area Network in English, and VXLAN may be the abbreviation of Virtual Extensible Local Area Network in English. NVGRE may be fully spelled as Network Virtualization using Generic Routing Encapsulation in English, and NVGRE may be the abbreviation of Network Virtualization using Generic Routing Encapsulation in English. IPv4 may be fully spelled as Internet Protocol version 4 in English, and IPv4 may be the abbreviation of Internet Protocol version 4 in English. IPv6 may be fully spelled as Internet Protocol version 6 in English, and IPv6 may be the abbreviation of Internet Protocol version 6 in English. PBB may be fully spelled as Provider Backbone Bridge in English, and PBB may be the abbreviation of Provider Backbone Bridge in English.

In the embodiments of the disclosure, GPRS may be fully spelled as general packet radio service in English, and GPRS may be the abbreviation of general packet radio service in English. PPPoE may be fully spelled as Point-to-Point Protocol over Ethernet in English, and PPPoE may be the abbreviation of Point-to-Point Protocol over Ethernet in English. CAPWAP may be fully spelled as Control And Provisioning of Wireless Access Points in English, and CAPWAP may be the abbreviation of Control And Provisioning of Wireless Access Points in English. MAC may be fully spelled as Media Access Control in English, and MAC may be the abbreviation of Media Access Control in English. VLAN may be fully spelled as virtual local area network in English, and VLAN may be the abbreviation of virtual local area network in English. TTL may be fully spelled as time to live in English, and TTL may be the abbreviation of time to live in English. TCP may be fully spelled as Transmission Control Protocol in English, and TCP may be the abbreviation of Transmission Control Protocol in English. UDP may be fully spelled as User Datagram Protocol in English, and UDP may be the abbreviation of User Datagram Protocol in English.

In the embodiments of the disclosure, API may be fully spelled as application programming interface in English, and API may be the abbreviation of application programming interface in English. TNI may be fully spelled as Tenant Network Identifier in English, and TNI may be the abbreviation of Tenant Network Identifier in English. VNI may be fully spelled as VXLAN Network Identifier in English, and VNI may be the abbreviation of VXLAN Network Identifier in English. I-SID may be fully spelled as Backbone Service Instance Identifier in English, and I-SID may be the abbreviation of Backbone Service Instance Identifier in English. DS-Lite may be fully spelled as Dual Stack Lite in English, and DS-Lite may be the abbreviation of Dual Stack Lite in English. MAP-E may be fully spelled as Mapping of Address and Port with Encapsulation in English, and MAP-E may be the abbreviation of Mapping of Address and Port with Encapsulation in English. LW4over6 may be fully spelled as light weight 4 over 6 in English, and LW4over6 may be the abbreviation of light weight 4 over 6 in English. 4RD may be fully spelled as IPv4 Residual Deployment in English, and 4RD may be the abbreviation of IPv4 Residual Deployment in English. 6RD may be fully spelled as IPv6 Rapid Deployment in English, and 6RD may be the abbreviation of IPv6 Rapid Deployment in English.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

The foregoing descriptions are merely exemplary specific embodiments of the disclosure, but are not intended to limit the protection scope of the present invention. Any variation or replacement readily figured out by a person skilled in the art within the technical scope disclosed in the present invention shall fall within the protection scope of the present invention.

What is claimed is:

1. A communication method for packet tunneling through a software defined network (SDN), said method comprising:
sending programmable instructions to an SDN controller from a processor executing an application program that includes said programmable instructions; wherein said programmable instruction comprises primitive operations regarding processing a packet for tunneling in accordance with a tunneling protocol;
configuring a flow table by said SDN controller in accordance with said programmable instructions; and
processing and distributing said packet in accordance with said flow table by an SDN switch.

2. The method according to claim 1, wherein said programmable instructions comprise pushing header operations for an SDN switch at a tunnel entry point, and/or popping header operations for an SDN switch at a tunnel exit point.

3. The method according to claim 1, wherein said programmable instructions comprise pushing metadata operations for an SDN switch at a tunnel entry point, and/or popping metadata operations for an SDN switch at a tunnel exit point, wherein said metadata comprise information for processing a packet for tunneling.

4. The method according to claim 1, wherein said tunneling protocol is selected from a group consisting of MPLS, PBB, IPv4-in-IPv6, IPv6-in-IPv4, GRE, VXLAN, NVGRE, GPRS, PPPoE, and CAPWAP.

5. The method according to claim 1, wherein said programmable instructions are sent from a processor executing an application program, wherein said programmable instructions are configured as data structures in said application program.

6. A system for tunneling used in a software defined network (SDN), comprising:
an SDN controller, configured to receive instructions comprise operations of adding tunneling information to and removing tunneling information from a packet in accordance with a tunneling protocol, said instructions sent from a processor executing an application program; and configure a flow table associated with an SDN switch in accordance with said instructions; and
an SDN switch, coupled to said SDN controller and configured to perform actions based on said flow table to distribute said packet in accordance with said tunneling protocol through said SDN network.

7. The system according to claim 6, wherein said instructions are independent of said SDN switch.

8. The system according to claim 6, wherein said instructions comprise pushing header operations for an SDN switch at a tunnel entry point, and/or popping header operations for an SDN switch at a tunnel exit point.

9. The system according to claim 6, wherein said instructions comprise pushing metadata operations for an SDN switch at a tunnel entry point, and/or popping metadata operations for an SDN switch at a tunnel exit point, wherein said metadata comprise information for processing a packet for tunneling.

10. The system according to claim 6, wherein said tunneling protocol is selected from a group consisting of MPLS, PBB, IPv4-in-IPv6, IPv6-in-IPv4, GRE, VXLAN, NVGRE, GPRS, PPPoE, and CAPWAP.

11. The system according to claim 7, wherein said instructions are sent from a processor executing an application program, wherein said instructions are configured as data structures in said application program.

12. A computer implemented method of intelligently controlling flow of a packet through an software defined network (SDN) network, said method comprising configuring primitive operations regarding processing a packet for tunneling in accordance with a tunneling protocol,
wherein said primitive operations comprise adding tunneling information to and/or removing tunneling information from a packet in accordance with said tunneling protocol,
wherein said primitive operations are used by an SDN controller to configure a flow table, and
wherein said flow table is used by an SDN switch to perform said primitive operations to distribute and/or receive a packet in accordance with said tunneling protocol.

13. The method according to claim 12, wherein said primitive operations comprise pushing header operations for an SDN switch at a tunnel entry point, and/or popping header operations for an SDN switch at a tunnel exit point.

14. The method according to claim 12, wherein said instructions comprise pushing metadata operations for an SDN switch at a tunnel entry point, and/or popping metadata operations for an SDN switch at a tunnel exit point, wherein said metadata comprise information for processing a packet for tunneling.

15. The method according to claim 12, wherein said tunneling protocol is selected from a group consisting of MPLS, PBB, IPv4-in-IPv6, IPv6-in-IPv4, GRE, VXLAN, NVGRE, GPRS, PPPoE, and CAPWAP.

16. A software defined network (SDN) controller, comprising:
a memory storing instructions; and
a processor coupled to the memory to execute the instructions to:
receive instructions comprise operations of adding tunneling information to and removing tunneling information from a packet in accordance with a tunneling protocol, said instructions sent from a processor executing an application program; and configure a flow table associated with an SDN switch in accordance with said instructions.

17. A software defined network (SDN) switch, wherein the SDN switch coupled to an SDN controller, the SDN switch comprises:
a memory storing instructions; and
a processor coupled to the memory to execute the instructions to:
perform actions based on a flow table to distribute a packet in accordance with a tunneling protocol through said SDN network, wherein the flow table is configured by said SDN controller.
